(19) United States
(12) Patent Application Publication
(10) Pub. No.: US 2009/0322858 A1
(43) Pub. Date: Dec. 31, 2009

(54) PICTURE SIGNAL PROCESSING DEVICE, TELEVISION RECEIVING APPARATUS AND METHOD OF CONTROLLING APPARATUS

(75) Inventors: Kota MITSUYA, Kodama-gun (JP); Toru MIYAZAKI, Fukaya-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/468,560

(22) Filed: May 19, 2009

(30) Foreign Application Priority Data
Jun. 27, 2008 (JP) 2008-169083

(51) Int. Cl. H04N 13/00; H04N 5/455; H04N 7/12

(52) U.S. Cl. 348/43; 348/726; 375/240.25; 348/E13.001; 348/E05.113; 375/E07.027

(57) ABSTRACT

According to one embodiment, in an apparatus according to the present invention, a first frame memory has an input portion to which a first picture signal for three-dimensional viewing is input. A second frame memory has an input unit to which a second picture signal for three-dimensional viewing or a third picture signal for frame rate conversion is input. A motion detection module detects a motion detection signal that indicates a motion in an image by use of the third picture signal. An interpolation frame generation module generates an interpolation frame picture signal by use of the third picture signal in accordance with the motion detection signal. A selection module selects either one of the interpolation frame picture signal and the first picture signal. And an output timing control module to which output picture signals are supplied from the selection module and the second frame memory.

### CROSS-REFERENCE TO RELATED APPLICATIONS

This application is based upon and claims the benefit of priority from Japanese Patent Application No. 2008-169083, filed Jun. 27, 2008, the entire contents of which are incorporated herein by reference.

### BACKGROUND

1. Field

One embodiment of the present invention relates to a picture signal processing device, a television receiving apparatus and a method of controlling the apparatus.

2. Description of the Related Art

Advances in the technology of manufacturing liquid crystal displays and plasma displays has increased the number of pixels and improved the resolution. In accordance with such advances, the technology in picture signal processing devices has been developed, in which the frame frequency of a picture signal is subjected to a double-speed conversion process and the resultant signal is output. The double-speed conversion process means, for example, that a picture signal of 30 frames/second is converted to a signal of 60 frames/second, or that a picture signal of 60 frames/second is converted to a signal of 120 frames/second.

On the other hand, a picture signal processing device that outputs a three-dimensional picture signal by use of a picture signal for stereoscopic viewing has been developed. Furthermore, a technology of selectively outputting a 3D picture, a high-resolution picture and a normal picture has been suggested (for example, Jpn. Pat. Appln. KOKAI Publication No. 8-331473).

The signal processing circuit which deals with various types of picture signals, tends to become large and require a large memory capacity.

### BRIEF DESCRIPTION OF THE SEVERAL VIEWS OF THE DRAWINGS

A general architecture that implements various features of the invention will now be described with reference to the drawings. The drawings and the associated descriptions are provided to illustrate embodiments of the invention and not to limit the scope of the invention.

FIG. 1 is a diagram showing an example of the fundamental structure of the present invention.

FIG. 2 is a diagram of process blocks, focusing on the double-speed conversion process of the block structure of FIG. 1.

FIG. 3 is a diagram of process blocks, focusing on the three-dimensional picture signal process of the block structure of FIG. 1.

FIG. 4 is a diagram showing an example structure of the present invention when it is applied to a television receiving apparatus.

### DETAILED DESCRIPTION

Various embodiments according to the invention will be described hereinafter with reference to the accompanying drawings.

According to the exemplary embodiments, the present invention is designed in such a manner that a three-dimensional picture signal processing circuit and a double-speed conversion processing circuit share as many modules as possible. The present invention thereby offers a picture signal processing device and a television receiving apparatus with downsized circuits at reduced production cost, as well as a method of controlling such an apparatus.

An embodiment of the present invention comprises: a first frame memory having an input portion to which a first picture signal for three-dimensional viewing is input; a second frame memory having an input portion to which a second picture signal for three-dimensional viewing or a third picture signal for double-speed conversion is input; a motion detection module configured to detect a motion detection signal that indicates a motion in an image by use of the third picture signal; an interpolation frame generation module configured to generate an interpolation frame picture signal by use of the third picture signal in accordance with the motion detection signal; a selection module configured to select either one of the interpolation frame picture signal and the first picture signal; and an output timing control module to which output picture signals are supplied from the selection module and the second frame memory.

According to the above embodiment, a circuit that selectively presents three-dimensional picture output and frame rate conversion picture output can be reduced in size and realized at low production cost.

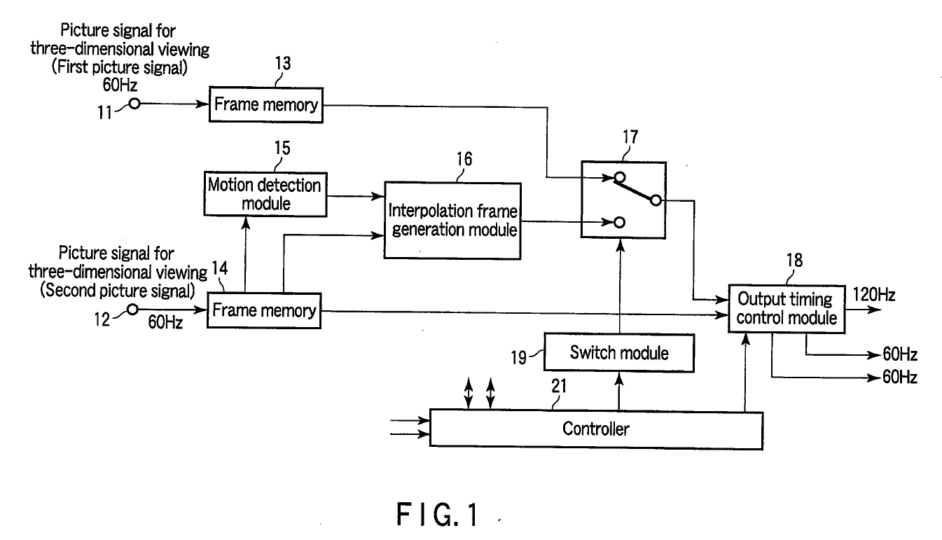

The present invention will now be described in detail below. The embodiments of the invention will be discussed with reference to the attached drawings. FIG. 1 shows the fundamental structure of the invention. For example, a three-dimensional left-eye viewing picture signal is supplied as a first picture signal to an input unit 11. The first picture signal is input to a frame memory 13. The picture signal output from the frame memory 13 is supplied to one of the input terminals of a selection module 17. The picture signal selected by the selection module 17 is then supplied to one of the input units of an output timing control module 18.

On the other hand, a three-dimensional right-eye viewing picture signal, for example, is supplied as a second picture signal, or a double-speed conversion picture signal is supplied as a third picture signal, to an input unit 12. The second or third picture signal is supplied to a frame memory 14.

The picture signal output from the frame memory 14 is supplied to the other input unit of the output timing module 18. By use of this picture signal from the frame memory 14, a motion detection module 15 detects any motion in the image and obtains a motion detection signal. The motion detection signal is supplied to an interpolation frame generation module 16. The interpolation frame generation module 16 generates an interpolation frame picture signal by use of the picture signal output from the frame memory 14 in accordance with the motion detection signal. The generated interpolation frame picture signal is supplied to the other input unit of the selection module 17.

In three-dimensional picture output mode, a switch module 19 controls the selection module 17 so that the selection module 17 selects the output of the frame memory 13. In double-speed conversion picture output mode, the switch module 19 controls the selection module 17 so that the selection module 17 selects the interpolation frame picture signal of the interpolation frame generation module 16.

The output timing control module 18 is configured to perform frame rate (double-speed) conversion on the picture signals of the selection module 17 and the frame memory 14 and output the resultant signals. The output timing control module 18 is also configured to output the picture signals of the selection module 17 and the frame memory 14 without making any change to the speed.

The three-dimensional picture output mode and the double-speed conversion mode are switched back and forth in response to a control signal that is supplied by a controller 21. Moreover, in accordance with the type of the three-dimensional display, a three-dimensional picture signal can be output at 120 Hz, or a three-dimensional left-eye-viewing picture signal of 60 Hz and a three-dimensional right-eye-viewing picture signal of 60 Hz can be separately output.

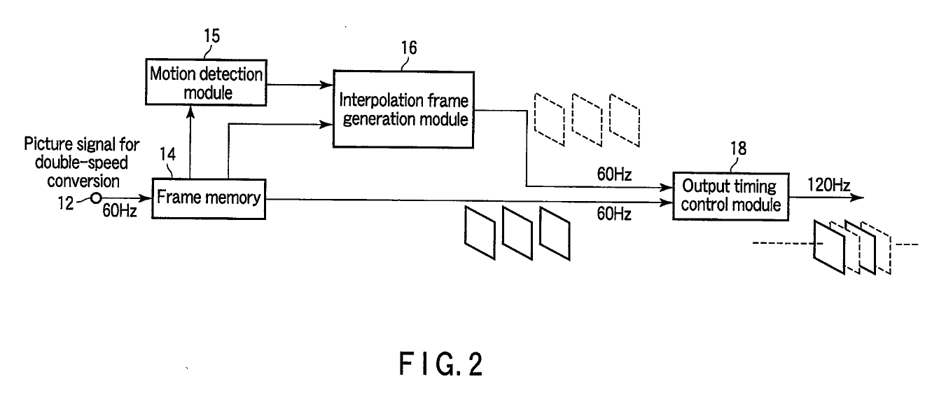

FIG. 2 shows blocks of the process that is performed when the aforementioned device operates in double-speed conversion mode. For example, a picture signal that is input at frame frequency of 60 Hz is supplied to the interpolation frame generation module 16, where an interpolation frame picture signal of 60 Hz is generated from the original picture frame. This interpolation frame picture signal and the picture signal of the frame memory 14 are subjected to double-speed conversion by the output timing control module 18, and output as picture signals of 120 Hz.

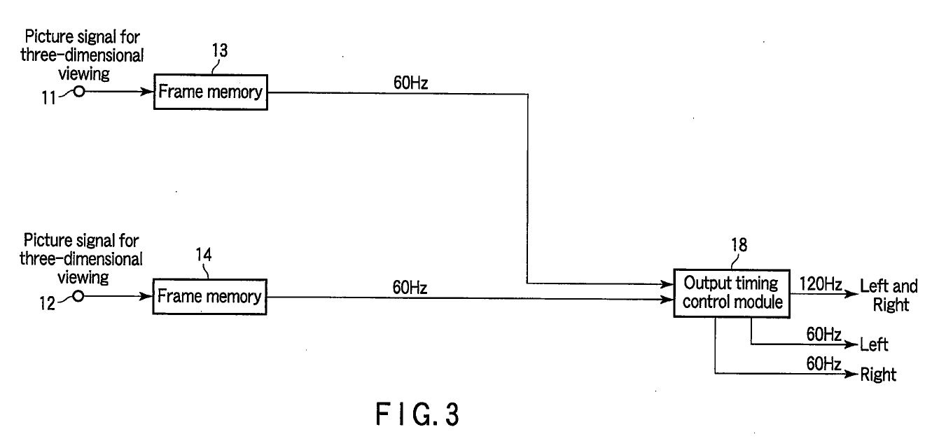

FIG. 3 shows blocks of the process that is performed when the aforementioned device operates in three-dimensional picture output mode. A three-dimensional left-eye-viewing picture signal of 60 Hz is input from the frame memory 13 to the output timing control module 18, and the three-dimensional right-eye-viewing picture signal of 60 Hz is input from the frame memory 14 to the module 18.

If the display is of a type that switches between the right-eye-viewing and left-eye-viewing picture signals at 120 Hz, these picture signals are subjected to double-speed conversion by the output timing control module 18 and output as picture signals of 120 Hz. Then, the viewer can view a three-dimensional picture on the display by wearing a pair of liquid-crystal glasses or the like that alternately switch on/off the left and right translucent portions in synchronization with the switching of the left and right viewing picture signals.

If the display is of a type that presents the left and right viewing picture signals of 60 Hz in the left and right regions side by side, the three-dimensional left-eye-viewing picture signal of 60 Hz and the three-dimensional right-eye-viewing picture signal of 60 Hz are output. A divider is provided in the middle so that the viewer can see the picture of the left-eye-viewing picture signal with the left eye and the picture of the right-eye-viewing picture signal with the right eye.

The picture may be viewed by projecting the output picture signals with a projector. For example, the right and left picture signals that are alternately output at 120 Hz may be polarized by left/right polarizing filters and projected on a screen. The viewer sees this screen by wearing a pair of polarized glasses that have left/right polarizing filters to view a three-dimensional picture.

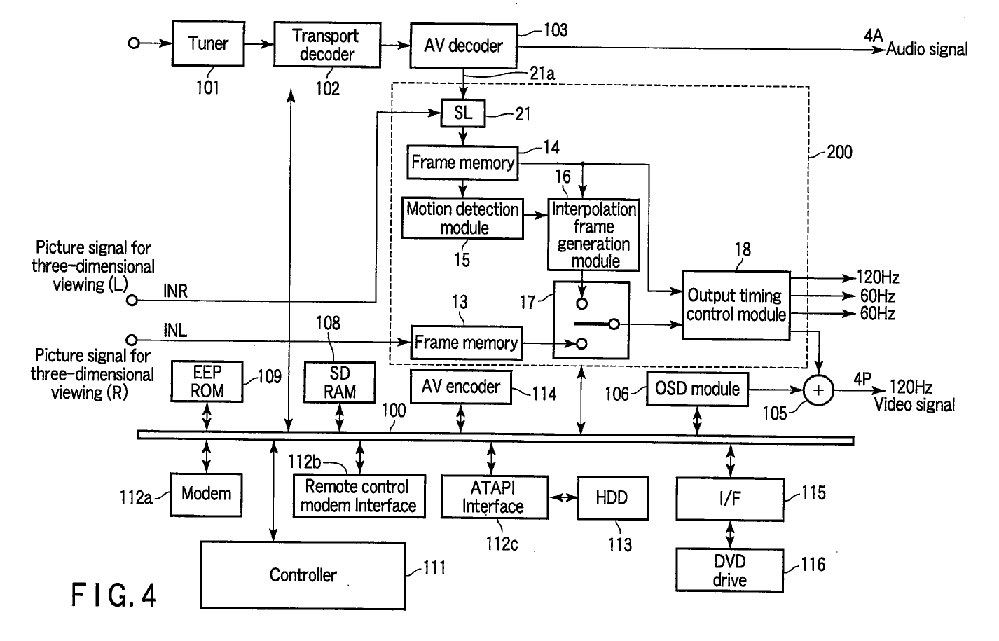

FIG. 4 shows a digital television receiving apparatus to which the present invention is applied. A tuner 101 receives, for example, a digital broadcast signal, decodes the received signal, and supplies the decoded signal to a transport decoder 102. The video and audio data of a program selected by the transport decoder 102 are input in packets to an audio/video (AV) decoder 103 for decoding.

The audio data decoded by the AV decoder 103 is output to an output terminal 4A, and the video data is output to a selector 21. The output of the selector 21 is input to the frame memory 14. The modules described with reference to FIG. 1 are integrated in an IC unit 200. The same components as those in FIG. 1 are given the same reference numerals. The video data output by the output timing control module 18 is supplied to an output terminal 4P. The video data of the output terminal 4P may be combined with video data of an on-screen display (OSD) module 106 by a superimposing module 105. The audio data is supplied to a speaker, while the video data is supplied to the display.

An SDRAM 108 is utilized to temporarily store data when, for example, an error correction process is performed on the received signal. An EEPROM 109 is utilized to store a program for executing functions of the device or parameters for such a program.

A main bus 100 is connected to the transport decoder 102, the AV decoder 103, the OSD module 106, the SDRAM 108, the EEPROM 109, and the like. The main bus 100 is also connected to a controller 111 that controls the entire apparatus. The apparatus may be connected to external devices by way of the bus 100. To realize this arrangement, a modem interface 112a, a remote control interface 112b, and an ATAPI interface 112c are connected to the main bus 100. A hard disk drive (HDD) 113 may be connected to the apparatus by way of the interface 112c.

AV streams separated by the transport decoder 102 may be stored in the HDD 113 by way of the ATAPI interface 112c. When the data is to be reproduced, the AV streams read from the HDD 113 are decoded by the AV decoder 103.

The AV decoder 103 can reproduce audio signals and video signals from a transport stream. The AV decoder 103 can also reproduce audio signals and video signals from DVD-standard audio and video streams. Moreover, the invention may be designed in such a manner that audio and video signals can be reproduced from signals of other standards.

An AV encoder 114 is connected to the main bus 100, and this AV encoder 114 converts the picture data to a certain format (DVD, transport stream, baseband, etc.) in order to store the picture data in a recording medium. The converted AV information is stored in the HDD 113, for example.

Further, a DVD drive 116 may be connected to the apparatus by way of an interface 115. The DVD-standard information may be recorded on and reproduced from an optical disk by way of the DVD drive 116. The controller 111 exercises centralized control over the aforementioned blocks.

Input terminals INL and INR are units to which three-dimensional picture signals L and R, respectively, are input. In the regular double-speed conversion mode, the controller 111 performs control so that the switch 17 selects the output of the interpolation frame generation module 16. In the three-dimensional picture display mode, the controller 111 performs control so that the switch 17 selects the output of the frame memory 13.

As described above, the television receiving apparatus of the present invention is provided with the IC unit 200 in which the first and second picture signals L and R are selected and output in the three-dimensional operation mode, and the third picture signal and the interpolation frame signal generated by use of the third picture signal are subjected to double-speed conversion and alternately output in the double-speed conversion mode.

The IC unit 200 comprises the input unit INR to which the first picture signal for three-dimensional viewing is input, the input unit INL to which the second picture signal for three-dimensional viewing is input, and an input unit 21a to which the third picture signal for double-speed conversion is input from the decoder 103.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A picture signal processing device comprising:
a first frame memory having an input portion to which a first picture signal for three-dimensional viewing is input;
a second frame memory having an input portion to which a second picture signal for three-dimensional viewing or a third picture signal for speed conversion is input;
a motion detection module configured to detect a motion detection signal that indicates a motion in an image by use of the third picture signal;
an interpolation frame generation module configured to generate an interpolation frame picture signal by use of the third picture signal in accordance with the motion detection signal;
a selection module configured to select either one of the interpolation frame picture signal and the first picture signal; and
an output timing control module to which output picture signals are supplied from the selection module and the second frame memory.

2. The picture signal processing device of claim 1, wherein the selection module selects the first picture signal that is output from the first frame memory in three-dimensional picture output mode, and selects the interpolation frame picture signal that is output from the interpolation frame generation module in a speed conversion picture output model.

3. The picture signal processing device of claim 1, wherein the first frame memory, the second frame memory, the motion detection module, the interpolation frame generation module, the selection module and the output timing control module are arranged in a single integrated circuit.

4. A television receiving apparatus that has a decoder for decoding a received broadcast signal, comprising;
a first input portion to which a first picture signal for three=dimensional viewing is input;
a second input portion to which a second picture signal for three-dimensional viewing is input;
a third input portion to which a third picture signal for speed conversion is input from the decoder; and
an IC module configured to select and to output the first and second picture signals in three-dimensional viewing operation mode, and to perform speed conversion mode on the third picture signal and an interpolation frame picture signal generated by use of the third picture signal and alternately outputting resultant signals.

5. The television receiving apparatus of claim 4, wherein the IC module comprises:
a first frame memory having an input portion to which the first picture signal for three-dimensional viewing is input;
a second frame memory having an input portion to which the second picture signal or the third picture signal is input;
a motion detection module configured to detect a motion detection signal that indicates a motion in an image by use of the third picture signal;
an interpolation frame generation module configured to generate an interpolation frame picture signal by use of the third picture signal in accordance with the motion detection signal;
a selection module configured to select either one of the interpolation frame picture signal and the first picture signal; and
an output timing control module to which output picture signals are supplied from the selection module and the second frame memory.

6. A method of controlling a television receiving apparatus that is provided with a decoder for decoding a received broadcast signal, comprising steps of:
inputting to blocks of an integrated circuit a first picture signal for three dimensional viewing, a second picture signal for three-dimensional viewing, and a third picture signal supplied from the decoder for speed conversion; and
selecting and outputting the first and second picture signals in three-dimensional viewing operation mode, and performing double-speed conversion on the third picture signal and an interpolation frame picture signal generated by use of the third picture signal and alternately obtaining resultant signals.
